(19) United States
(12) Patent Application Publication
(10) Pub. No.: US 2022/0289523 A1
(43) Pub. Date: Sep. 15, 2022

(54) DYNAMIC STOPPER/S IN AN ELEVATOR CAR

(71) Applicant: Otis Elevator Company, Farmington, CT (US)

(72) Inventors: PavanKumar Swayampakala, Bangalore (IN); Ramananda Nayak, Bangalore (IN); Vinay Bushan, Bangalore (IN); Ravi N, Bangalore (IN)

(21) Appl. No.: 17/513,499

(22) Filed: Oct. 28, 2021

(30) Foreign Application Priority Data
Mar. 9, 2021 (IN) 202111009894

(51) Int. Cl. B66B 13/14; B66B 11/02; B66B 13/06; B66B 1/46

(52) U.S. Cl. CPC B66B 13/143; B66B 11/0226; B66B 13/06; B66B 1/46

(57) ABSTRACT

A system and a method for operating one or more dynamic stoppers in an elevator car. A method includes receiving a command at one or more control panels to switch one or more dynamic stoppers from a first position to a second position. The one or more dynamic stoppers are installed on a platform of an elevator car. The elevator car includes one or more doors and the one or more control panels is installed in the elevator car. The method includes switching the one or more dynamic stoppers from the first position to the second position using one or more actuators coupled to the one or more dynamic stoppers, respectively.

### FOREIGN PRIORITY

This application claims priority to Indian Patent Application No. 202111009894, filed Mar. 9, 2021, and all the benefits accruing therefrom under 35 U.S.C. § 119, the contents of which in its entirety are herein incorporated by reference.

### TECHNICAL FIELD

The present disclosure generally relates to elevator systems. More particularly, the invention relates to a system and a method for stopping trolleys against one or more dynamic stoppers in an elevator car.

### BACKGROUND

Elevator cars are used in buildings for carrying passengers, luggage, trolleys etc. from one floor to another floor. The elevator cars may have walls/doors made of materials that can be easily damaged, for instance glass. It may happen that sometimes, carelessly or accidently, luggage or trolleys or any other item hits into glass walls/doors of the elevator cars. This may result in damaging the glass walls/doors which, in turn, may adversely affect their aesthetics and/or operational capabilities. Currently, there does not exist any mechanism or solution that can prevent an item such as a piece of luggage or a trolley from hitting the glass walls/doors of an elevator car while moving it inside or outside the elevator car during movement/rest condition of the elevator car.

In view of the afore-mentioned problems, there is a need of an effective and efficient system and a method for preventing items such as luggage or trolleys from hitting walls/glass doors of an elevator car. There is also a requirement to prevent damage caused to the glass walls/doors of an elevator car while moving luggage or trolleys inside or outside the elevator car. In order to solve the problems in the existing solutions, a system and a method are disclosed.

### SUMMARY

Various embodiments of the invention describe an elevator system for operating one or more dynamic stoppers in an elevator car. The elevator system comprises an elevator car and one or more actuators. The elevator car comprises one or more doors, a platform for accommodating at least one trolley, one or more control panels and one or more dynamic stoppers installed on the platform. The one or more dynamic stoppers are configured to operate in a first position and a second position. Further, the one or more actuators are coupled to the one or more dynamic stoppers, respectively and are configured to switch the one or more dynamic stoppers from the first position to the second position when a command is provided from the one or more control panels.

In an embodiment of the invention, the one or more doors comprise a front door and a rear door of the elevator car. Further, the one or more control panels comprise a first control panel located near to the front door and a second control panel located near to the rear door

In a different embodiment of the invention, the one or more dynamic stoppers comprise a front-end stopper (FES) installed near the front door and a rear-end stopper (RES) installed near the rear door of the elevator car.

In an embodiment of the invention, the one or more actuators comprise a front-end actuator coupled to the front-end stopper and a rear-end actuator coupled to the rear-end stopper, respectively.

In another embodiment of the invention, the front-end actuator and the rear-end actuator operate in an expanded position to articulate the front-end stopper and the rear-end stopper to the second position.

In yet another embodiment of the invention, the front-end actuator and the rear-end actuator operate in a retracted position to articulate the front-end stopper and the rear-end stopper to the first position

In another embodiment of the invention, the first position corresponds to a position of the one or more dynamic stoppers grounded along the platform and the second position corresponds to a position of the one or more dynamic stoppers elevated from the platform.

In still another embodiment of the invention, in the second position, the one or more dynamic stoppers are elevated at a predetermined angle with respect to the platform based on a diameter of a roller of the at least one trolley.

In a different embodiment of the invention, the front-end stopper operates in the second position and the rear-end stopper operates in the first position when the at least one trolley enters from the rear door. Further, the front-end stopper and the rear-end stopper operate in the first position when the at least one trolley exits from the front door.

In yet another embodiment of the invention, the command from each of the one or more control panels is provided by an operator, wherein the operator inserts a physical key and presses a key switch button on the one or more control panels.

In an embodiment of the invention, the front-end stopper operates in the first position and the rear-end stopper operates in the second position when the at least one trolley enters from the front door. Also, the front-end stopper and the rear-end stopper operate in the first position when the at least one trolley exits from the rear door.

In yet another embodiment of the invention, the one or more dynamic stoppers switch from the first position to the second position when the key switch button and the dedicated button is operated by the operator.

In another embodiment of the invention, each of the one or more actuators is coupled to an arm and the arm is installed on a flange connected to the platform.

In yet another embodiment of the invention, each of the one or more actuators is connected with one or more components and the one or more components is connected with each of the one or more control panels.

In an embodiment of the invention, each of the one or more control panels communicates the command to the one or more components when a command is provided at the one or more control panels and the one or more components communicates the command to the one or more actuators.

In yet another embodiment of the invention, the front-end actuator and the rear-end actuator operate in the expanded position on receiving a command from the one or more components enabling the one or more dynamic stoppers to operate in the second position.

In a different embodiment of the invention, the one or more dynamic stoppers operating in the first position do not restrict the movement of the at least one trolley. Further, the one or more dynamic stoppers operating in the second position restrict the movement of the at least one trolley.

In yet another embodiment of the invention, the one or more dynamic stoppers automatically switch from the first position to the second position based on inputs from one or more sensors installed in the elevator car.

In a different embodiment of the invention, the one or more dynamic stoppers automatically switch from the second position to the first position based on a door opening signal when the elevator car reaches a destination floor.

Various embodiments of the invention describe a method for operating one or more dynamic stoppers in an elevator car. The method comprises the step of receiving a command at one or more control panels to switch one or more dynamic stoppers from a first position to a second position. Also, the one or more dynamic stoppers are installed on a platform of an elevator car and the elevator car comprises one or more doors. Further, the one or more control panels is installed in the elevator car. The method also comprises the step of switching the one or more dynamic stoppers from the first position to the second position using one or more actuators coupled to the one or more dynamic stoppers respectively.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Other aspects, advantages, and salient features of the invention will become apparent to those skilled in the art from the following detailed description, which taken in conjunction with the annexed drawings, discloses exemplary embodiments of the invention.

### BRIEF DESCRIPTION OF THE DRAWINGS

FIG. 1A depicts an exemplary elevator system according to an exemplary embodiment of the invention.

FIG. 1B depicts an exemplary elevator system according to another exemplary embodiment of the invention.

FIG. 2A depicts an exemplary first control panel of an elevator car according to an exemplary embodiment of the invention.

FIG. 2B depicts an exemplary second control panel of an elevator car according to an exemplary embodiment of the invention.

FIG. 3A depicts an exemplary dynamic stopper in a first position according to an exemplary embodiment of the invention.

FIG. 3B depicts an exemplary dynamic stopper in a second position according to an exemplary embodiment of the invention.

FIG. 3C depicts an exemplary trolley with an exemplary dynamic stopper according to an exemplary embodiment of the invention.

FIG. 3D depicts a cross-sectional view of the exemplary dynamic stopper in a second position according to an exemplary embodiment of the invention.

FIG. 4 depicts block diagram of different components of an exemplary one or more components according to an exemplary embodiment of the invention.

FIG. 5 depicts an exemplary flowchart illustrating a method to perform the invention according to an exemplary embodiment of the invention.

Corresponding reference numerals indicate corresponding parts throughout the drawings.

### DETAILED DESCRIPTION

Described herein is a technology with a system and a method for operating one or more dynamic stoppers in an elevator car. The one or more dynamic stoppers may be coupled with one or more actuators, respectively and may be operated in a first position and a second position. To switch the one or more dynamic stoppers from the first position to the second position or vice-versa, a command may be provided to one or more control panels installed in the elevator car. By operating the one or more dynamic stoppers in the second position, movement of at least one trolley can be restricted while moving the trolley inside the elevator car or during entering or exiting the elevator car. As a result, this would prevent at least one trolley from hitting glass doors of the elevator car and also prevent damage caused to the glass doors of the elevator car while moving the at least one trolley inside or outside the elevator car.

As used herein, the elevator car may be installed in a building or outside of the building. At least one side of the elevator car may have a door. The elevator car may carry passengers, luggage and/or one or more trolleys from one floor to another floor.

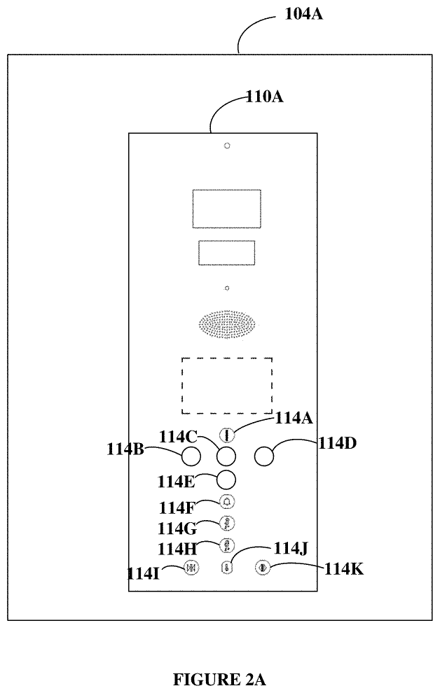

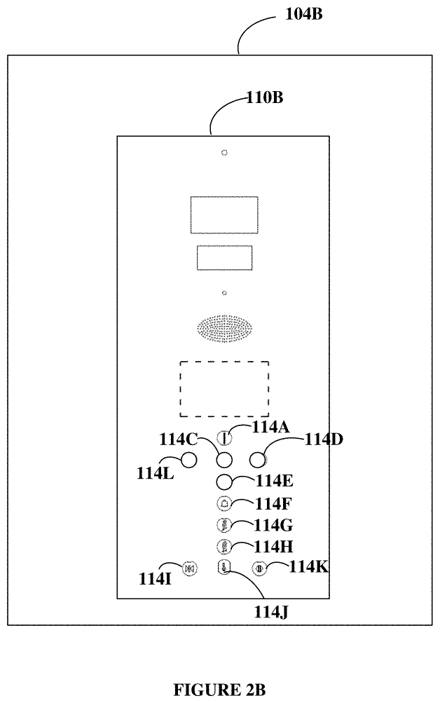

As used herein, the one or more control panels may comprise a first control panel located near a front door of the elevator car and a second control panel located near a rear door of the elevator car. Each of the control panels may have numerous buttons which can be used by an operator to provide command/s to operate the elevator car as well as the one or more dynamic stoppers. The first control panel is described in greater details in FIG. 2A and the second control panel is described in greater details in FIG. 2B.

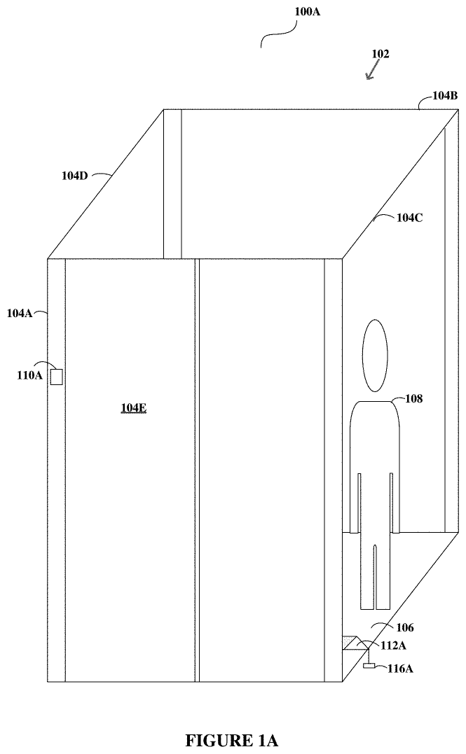

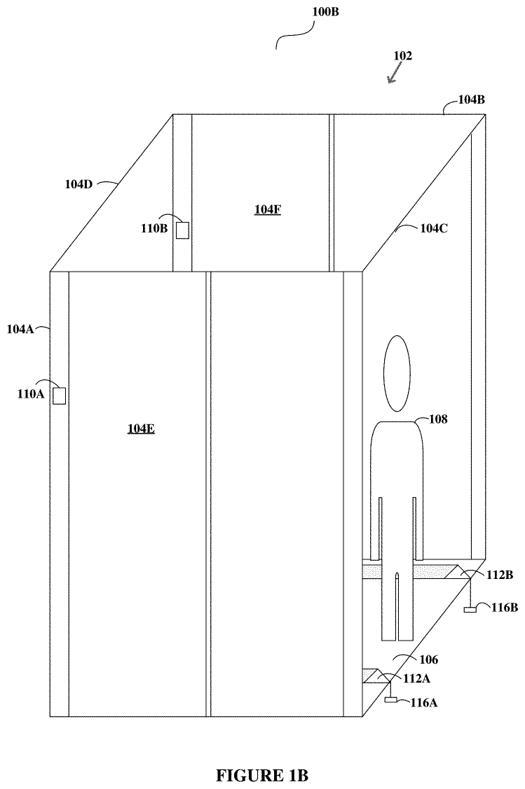

FIG. 1A depicts an exemplary elevator system 100A according to an exemplary embodiment of the invention. As depicted in FIG. 1A, the elevator system 100A comprises an elevator car 102 installed in a building, a dynamic stopper 112A and an actuator 116A. The elevator car 102 comprises one or more sides namely, a first side 104A, a second side 104B, a third side 104C, and a fourth side 104D. As can be seen, a front door 104E is located at the first side 104A. The elevator car 102 also comprises a platform 106 to accommodate at least one trolley, passengers and/or luggage. Further, the elevator car 102 may accommodate a maximum number of trolleys depending upon a width & a depth of the elevator car 102 and also on a size of the trolleys.

In this exemplary embodiment, the dynamic stopper 112A may be a front-end stopper (FES) 112A installed near the front door 104E. Also, the front-end stopper (FES) 112A is installed on the platform 106 and is configured to operate in a first position and a second position. Further, the actuator 116A may be a front-end actuator 116A coupled to the front-end stopper 112A. The elevator car 102 further comprises a first control panel 110A installed near the first side 104A of the elevator car 102. Also shown in FIG. 1A is an operator 108 standing on the platform 106 who can provide command/s to the first control panel 110A by pressing one or more buttons provided therein. The working of the front-end stopper 112A, the front-end actuator 116A and operating of the first control panel 110A is explained in Figures below.

In FIG. 1A, the front-end stopper (FES) 112A is installed on the platform 106 and is configured to operate in a first position and a second position. Furthermore, a front-end actuator 116A is coupled to the front-end stopper 112A. In addition, the front-end actuator 116A is configured to operate in a retracted position and an expanded position. In particular, operating the front-end actuator 116A in the retracted position would articulate the front-end stopper 112A to the first position. And, operating the front-end actuator 116A in the expanded position would articulate the front-end stopper 112A to the second position.

In an exemplary embodiment, the first position of the front-end stopper 112A corresponds to a position of the front-end stopper 112A grounded along the platform 106 and the second position of the front-end stopper 112A corresponds to a position of the front-end stopper 112A elevated from the platform 106.

FIG. 1B depicts an exemplary elevator system 100B according to an exemplary embodiment of the invention. In this exemplary embodiment, the elevator system 100B comprises two dynamic stoppers 112A, 112B and two actuators 116A, 116B. As can also be seen in FIG. 1B, the elevator system 100B comprises two doors namely, a front door 104E is located at the first side 104A and a rear door 104F is located at the second side 104B of the elevator car 102. The elevator car 102 also comprises a platform 106 to accommodate at least one trolley, passengers and/or luggage. Further, the elevator car 102 may accommodate a maximum number of trolleys depending upon a width & a depth of the elevator car 102 and also on a size of the trolleys. In varying embodiments, the elevator car 102 may have more or fewer than four sides and may additionally have only one door. In this embodiment, the elevator car 102 may include one or more dynamic stoppers comprise a front-end stopper (FES) 112A installed near the front door 104E and a rear-end stopper (RES) 112B installed near the rear door 104F of the elevator car 102.

In FIG. 1B, each of the front-end stopper (FES) 112A and the rear-end stopper (RES) 112B is installed on the platform 106 and is configured to operate in a first position and a second position. Furthermore, the one or more actuators comprises a front-end actuator 116A coupled to the front-end stopper 112A and a rear-end actuator 116B coupled to the rear-end stopper 112B. In addition, the front-end actuator 116A and/or the rear-end actuator 116B are configured to operate in a retracted position and an expanded position, In specific, operating the front-end actuator 116A in the retracted position would articulate the front-end stopper 112A to the first position. In the same way, operating the rear-end actuator 116B in the retracted position would articulate the rear-end stopper 112B to the first position. And, operating the front-end actuator 116A in the expanded position would articulate the front-end stopper 112A to the second position. Similarly, operating the rear-end actuator 116B in the expanded position would articulate the rear-end stopper 112B to the second position. The functioning of the front-end stopper 112A and the rear-end stopper 112B with respect to the front-end actuator 116A and/or the rear-end actuator 116B is explained below in FIGS. 2A-2B.

In an exemplary embodiment, the first position of the front-end stopper 112A corresponds to a position of the front-end stopper 112A grounded along the platform 106 and the second position of the front-end stopper 112A corresponds to a position of the front-end stopper 112A elevated from the platform 106. Similarly, the first position of the rear-end stopper 112B corresponds to a position of the rear-end stopper 112B grounded along the platform 106 and the second position of the rear-end stopper 112B corresponds to a position of the rear-end stopper 112B elevated from the platform 106.

Although the FIGS. 1A and 1B only shows a few components/modules of the elevator system 100A/100B; however, it is understood that for a person skilled in the art the elevator system 100A/100B also comprises other components/modules of the elevator system such as a position encoder, a controller, a machine, drive sheaves, ropes, counterweight, safety device, governor, buffer etc. which are not shown and explained herein.

FIG. 1A also depicts a first control panel 110A installed at the first side 104A and near to the front door 104E of the elevator car 102. Although, the first control panel 110A is shown as installed at the first side 104A; however, it is understood for a person skilled in the art that the first/second control panel 110A can also be installed anywhere in the elevator car 102 but near to the front door 104E, respectively. As shown in FIG. 1A is an operator 108 standing on the platform 106 who can provide command/s to the first control panel 110A by pressing one or more buttons provided therein. The operator 108 may use the first control panel 110A when the operator 108 enters in the elevator car 102 from the front door 104E.

Furthermore, the elevator car 102 may be operated in a trolley mode and/or a passenger mode. The trolley mode may refer to a mode where the trolley/s are transported from a start floor to a destination floor using the elevator car 102. In the trolley mode, the operator 108 may operate the front-end stopper 112A and the rear-end stopper 112B on need basis. The passenger mode may refer to a mode where passengers are transported from a start floor to a destination floor using the elevator car 102. By default, or when the elevator car 102 enters into the passenger mode, the front-end stopper 112A operates in the first position. That is, the front-end stopper 112A remain grounded along the platform 106. Also, the elevator car 102 can be operated in the trolley mode by the operator 108 on using dedicated button/s as explained below. The explanation of operating the control panel 110A is provided in FIG. 2A.

FIG. 2A depicts an exemplary first control panel 110A installed on a first side 104A of an elevator car 102 according to an exemplary embodiment of the invention. As can be seen, the first control panel 110A may comprise a key-switch button 114A, a rear open button 114B, a rear ground button 114C, a front ground button 114D, a door hold button 114E, an alarm button 114F for raising an alarm, destination input buttons 114G-114H, a door close button 1141 for closing a front door 114E, a key insertion location 114J and a door open button 114K for opening the front door 114E. In an exemplary embodiment, access using the physical key may be replaced by configuring a numeric keypad where key may be provided in the form of numeric or alphanumeric keys to initiate the trolley mode as described below.

FIG. 1B also depicts a first control panel 110A installed at the first side 104A and near to the front door 104E of the elevator car 102 as well as a second control panel 110B installed at the second side 104B and located near to the rear door 104F of the elevator car 102. Although, the first control panel 110A is shown as installed at the first side 104A and the second control panel 110B installed at the second side 104B of the elevator car 102; however, it is understood for a person skilled in the art that the first/second control panels 110A-110B can also be installed anywhere in the elevator car 102 but near to the front door 104E and the rear door 104F, respectively. Also shown in FIGS. 1A/1B is an operator 108 standing on the platform 106 who can provide command/s to the first control panel 110A and/or the second control panel 110B by pressing one or more buttons provided therein. The operator 108 may use the first control panel 110A when the operator 108 enters in the elevator car 102 from the front door 104E and may use the second control panel 110B when the operator 108 enters in the elevator car 102 from the rear door 104F. Stated otherwise, the operator 108 may not use the first control panel 110A when the operator 108 along with the trolley/s enter in the elevator car 102 from the rear door 104F. In this situation, accessing and operating the first control panel 110A is difficult when there are trolleys in the elevator car 102 and the operator 108 is standing near to the rear door 104F. Likewise, the operator 108 may not use the second control panel 110B when the operator 108 along with the trolley/s enter in the elevator car 102 from the front door 104E. In this situation, accessing and operating the second control panel 110B is difficult when there are trolleys in the elevator car 102 and the operator 108 is standing near to the front door 104E.

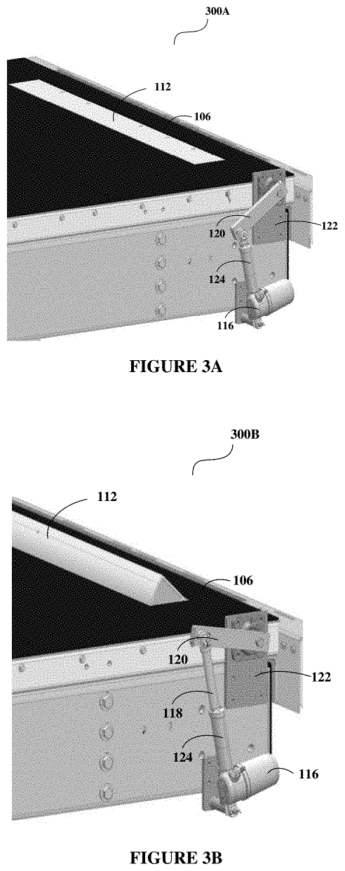

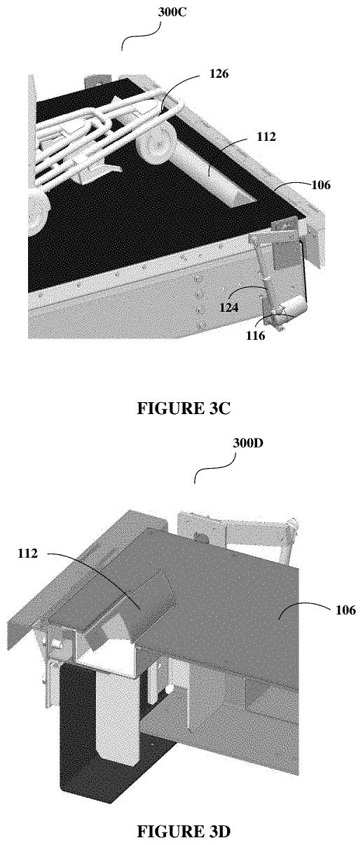

Furthermore, the elevator car 102 may be operated in a trolley mode and/or a passenger mode. The trolley mode may refer to a mode where the trolley/s are transported from a start floor to a destination floor using the elevator car 102. In the trolley mode, the operator 108 may operate the front-end stopper 112A and the rear-end stopper 112B on need basis. The passenger mode may refer to a mode where passengers are transported from a start floor to a destination floor using the elevator car 102. By default, or when the elevator car 102 enters into the passenger mode, the front-end stopper 112A and the rear-end stopper 112B operate in the first position. That is, the front-end stopper 112A and the rear-end stopper 112B remain grounded along the platform 106. Also, the elevator car 102 can be operated in the trolley mode by the operator 108 on using dedicated button/s as explained below the explanation of operating the control panel 110A/110B is provided in FIGS. 2A-2B and the working of the one or more dynamic stoppers 112A, 112B and the one or more actuators 116A, 116B is described in FIGS. 3A-3B.

The operation of the first control panel 110A and the second control panel 110B are same and uses same buttons for operation. The operation of the second control panel 110B is not discussed for brevity.

Scenario I

Considering an exemplary scenario where the operator 108 enters into the elevator car 102 from the front door 104E of the elevator car 102 stationed at a ground floor of the building.

On entering the elevator car 102 from the front door 104E, the operator 108 may first operate the door hold button 114E. By pressing this button at the first control panel 110A, the front door 104E of the elevator car 102 may remain open for a pre-determined interval of time allowing the trolleys to move inside or boarding the trolleys in the elevator car 102. Simultaneously, the operator 108 may operate the elevator car 102 in the trolley mode by operating the key-switch button 114A. In an exemplary embodiment, the operator 108 may insert a physical key at the key insertion location 114J and press the key-switch button 114A to unlock the trolley mode so that the elevator car 102 can be operated in the trolley mode. In another exemplary embodiment, the operator 108 may enter a key (numeric or alphanumeric) or a PIN (Personal Identification number) at a display (not shown) provided in the elevator car 102 to operate the elevator car 102 in the trolley mode. In yet another exemplary embodiment, the operator 108 may provide a biometric input at the display provided in the elevator car 102 to operate the elevator car 102 in the trolley mode. In a different exemplary embodiment, the operator 108 may use an access card using a Bluetooth/NFC communication in the elevator car 102 for identification to operate the elevator car 102 in the trolley mode. In another exemplary embodiment, the trolley mode may be activated automatically using a camera in the elevator car 102 or a hallway or by using a sensor in the elevator car 102 or in the doorway. In this embodiment, the trolley mode may be activated when the camera or a sensor detects an authorized person in the elevator car 102 or approaching it. It may be noted here that for using the elevator car 102 in the trolley mode, the present invention ensures that only an authorized operator/person can use the elevator car 102 in the trolley mode. This feature also prevents the unauthorized use of the trolley mode by passengers and or any user of the elevator car 102.

In an exemplary embodiment of the present invention, after inserting the physical key at the key insertion location 114J and when the operator 108 operates the key-switch button 114A in the elevator car 102, a command is generated from the first control panel 110A which may be communicated to one or more components (such as electrical and electronics components) via wired/wireless communication. Such one or more components may be integrated in the control panel 110A/110B or may be integrated in the elevator system 100A/100B.

Accordingly, the one or more components may communicate a command to the front-end actuator 116A when there is only a front-end actuator and a front door of the elevator car (as shown in FIG. 1A). The front-end stopper 112A may be operated in the second position only by using a single button i.e., key-switch button 114A.

In this embodiment, the present invention also encompasses operation of the front-end stopper 112A in the second position by using two or more dedicated buttons which is explained herein. After inserting the key into the key insertion location 114J and operating the key-switch button 114A, the operator 108 may provide a command by pressing the front ground button 114D at the first control panel 110A to operate the front-end stopper 112A in the first position. It may be noted here that the operator 108 may only use the front ground button 114D when the front-end stopper 112A is not in the first position. Operating the front-end stopper 112A in the first position would enable the trolley(s) to enter the elevator car 102 from the front door 104E.

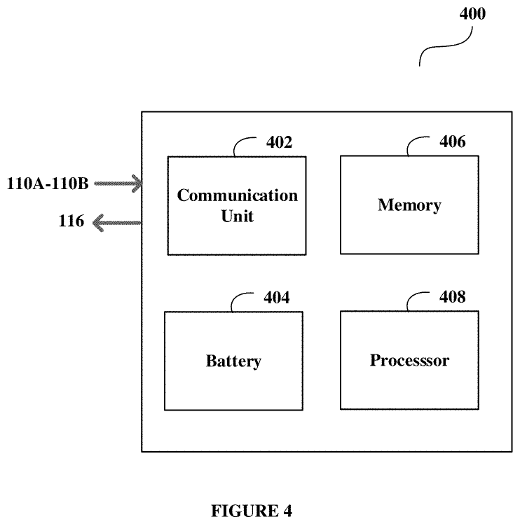

After boarding the trolleys, the operator may provide command to operate the front-end stopper in second position. Operating the front-end stopper in the second position would restrict the movement of trolleys towards the front door. When the operator 108 provides the command by pressing the front ground button 114E at the first control panel 110A, the first control panel 110A may communicate a command to a one or more components (shown in FIG. 4). The first control panel 110A may be connected with the one or more components via a wired connection or a wireless connection.

After the trolley(s) are in the elevator car 102 with the required operation of the front-end stopper 112A, the operator 108 selects a destination floor as 8^{th} floor (for example) in the building by pressing the button 114G-114H at the first control panel 110A. In another embodiment, the operator 108 may wish to move the elevator car 102 from the ground/bottom floor to any of the floors (e.g., top floor).

In an exemplary embodiment, when the elevator car 102 reaches the 8^{th} floor, a door open signal from a controller (not shown) of the elevator system 100A/100B along with position information of the elevator car 102 may be communicated to the one or more components. Based on the door open signal and the position information, the one or more components may determine that the elevator car 102 has reached the destination floor and the rear door 104F has been opened. On receiving the door open signal and the position information (i.e., 8^{th} floor), the one or more components may communicate a command to the front-end actuator 116A (via a wired connection or a wireless connection) to switch from the expanded position to the retracted position and thereby, operating the front-end stopper 112A in the first position again. The at least one trolley may exit or deboard the elevator car 102 from the front door 104E.

In another exemplary embodiment, when both the front-end actuator 116A and the rear-end actuator 116B are installed in the elevator car, the one or more components may communicate the command to the front-end actuator 116A and the rear-end actuator 116B to operate in an expanded position (as shown in FIG. 1B). This would in turn articulate the front-end stopper 112A and the rear-end stopper 112B to operate from the first position to the second position. This embodiment of the present invention would operate the front-end stopper 112A and the rear-end stopper 112B in the second position only by using a single button i.e. key-switch button 114A. In a different exemplary embodiment, the present invention also encompasses the other embodiment where the front-end stopper 112A and the rear-end stopper 112B can be operated in the second position by using two or more dedicated buttons which is explained herein below. In this different exemplary embodiment, after inserting the key into the key insertion location 114J and operating the key-switch button 114A, the operator 108 may provide a command by pressing the front ground button 114D at the first control panel 110A to operate the front-end stopper 112A in the first position and by pressing the rear open button 114B to operate the rear-end stopper 112B in the second position. It may be noted here that the operator 108 may only use the front ground button 114D when the front-end stopper 112A is not in the first position. In this situation, the rear-end stopper 112B switches from the first position to the second position. Operating the front-end stopper 112A in the first position would enable the trolley(s) to enter the elevator car 102 from the front door 104E and operating the rear-end stopper 112B in the second position would restrict movement of the trolley(s) from reaching/touching the rear door 104F of the elevator car 102.

It may be noted that after boarding the trolleys, the operator may provide command to operate both the front-end stopper and the rear-end stopper in second position. Operating both the front-end stopper and the second-end stopper would restrict the movement of trolleys towards the front door as well as towards the rear door.

When the operator 108 provides the command by pressing the front ground button 114D and the rear open button 114B at the first control panel 110A, the first control panel 110A may communicate a command to a one or more components (shown in FIG. 4). The first control panel 110A may be connected with the one or more components via a wired connection or a wireless connection. The one or more components may further communicate this command to the rear-end actuator 116B. Herein, the one or more components may be connected with the rear-end actuator 116B via a wired connection or a wireless connection. Specifically, the one or more components may only communicate the command to the rear-end actuator 116B so as to switch the rear-end stopper 112B from the first position to the second position. In this case, the one or more components does not communicate the command to the front-end actuator 116A when the front-end stopper 112A is already in the first position and thus, does not need to be changed/switched. On receiving the command from the one or more components, the rear-end actuator 116B switches from the retracted position to the expanded position. Switching of the rear-end actuator 116B from the retracted position to the expanded position enables the rear-end stopper 112B to switch the first position to the second position and thereby, operating the rear-end stopper 112B in the second position.

Referring to FIG. 3A, the actuator 116 (116A, 116B) is operating in the retracted position thereby, enabling the dynamic stopper 112 (112A, 112B) coupled with the actuator 116 to operate in the first position (i.e., grounded along with the platform 106). Referring to FIG. 3B of the present invention, the actuator 116 (116A, 116B) is operating in the expanded position thereby, enabling the dynamic stopper 112 (112A, 112B) coupled with the actuator 116 to operate in the second position (i.e., elevated from the platform 106).

After the trolley(s) are in the elevator car 102 with the required operation of the front-end stopper 112A and the rear-end stopper 112B, the operator 108 selects a destination floor as 8^{th} floor (for example) in the building by pressing the button 114G-114H at the first control panel 110A. In another embodiment, the operator 108 may wish to move the elevator car 102 from the ground/bottom floor to any of the floors (e.g. top floor).

In an exemplary embodiment, when the elevator car 102 reaches the 8^{th} floor, a door open signal from a controller (not shown) of the elevator system 100A/100B along with position information of the elevator car 102 may be communicated to the one or more components. Based on the door open signal and the position information, the one or more components may determine that the elevator car 102 has reached the destination floor and the rear door 104F has been opened. On receiving the door open signal and the position information (i.e., 8^{th} floor), the one or more components may communicate a command to the rear-end actuator 116B (via a wired connection or a wireless connection) to switch from the expanded position to the retracted position and thereby, operating the rear-end stopper 112B in the first position again. When the rear-end stopper 112B operates in the first position, the at least one trolley may exit or deboard the elevator car 102 from the rear door 104F. In this embodiment, the rear-end stopper 112B automatically switches or operates from the second position to the first position without any command provided by the operator 108 on the first control panel 110A

In another exemplary embodiment, when the elevator car 102 reaches the 8^{th} floor, the operator 108 may provide a command by pressing the rear ground button 114C at the first control panel 110A to operate the rear-end stopper 112B in the first position i.e. to switch from the second position to the first position. On receiving the command, the first control panel 110A may communicate the command to the one or more components which may further communicate the command to the rear-end actuator 116B via a wired connection or a wireless connection. On receiving the command from the one or more components, the rear-end actuator 116B switches from the expanded position to the retracted position and thereby, operating the rear-end stopper 112B in the first position again. When the rear-end stopper 112B operates in the first position, the at least one trolley may exit the elevator car 102 from the rear door 104F.

FIG. 2B depicts an exemplary second control panel 110B installed on a second side 104B of an elevator car 102 according to an exemplary embodiment of the invention. As can be seen, the second control panel 110B may comprise the key-switch button 114A, a front open button 114L, the rear ground button 114C, the front ground button 114D, the door hold button 114E for open and hold the rear door 104F, the alarm button 114F for raising an alarm, the destination input buttons 114G-114H, a door close button 1141 for closing a rear door 114F, a key insertion location 114J for inserting a physical key and the door open button 114K for opening the rear door 114F. It is to be noted here that the operations of the key-switch button 114A, the rear ground button 114C, the front ground button 114D, the alarm button 114F and the destination input buttons 114G-114H are same as explained in the first control panel 110A.

Scenario II

Considering another exemplary scenario where the operator 108 enters from the rear door 104F of the elevator car 102 stationed at the 8^{th} floor of the building.

In a different exemplary embodiment where the front-end stopper 112A and the rear-end stopper 112B can be operated in the second position by using two or more buttons which is explained herein below. In this different exemplary embodiment, after inserting a physical key at the key insertion location 114J and operating the key-switch button 114A, the operator 108 may provide a command by pressing the front open button 114L at the second control panel 110B to operate the front-end stopper 112A in the second position and by pressing the rear ground button 114C to operate the rear-end stopper 112B in the first position. In this situation, the front-end stopper 112A switches from the first position to the second position. Operating the rear-end stopper 112B in the first position would enable the trolley(s) to enter the elevator car 102 from the rear door 104F and operating the front-end stopper 112A in the second position would restrict movement of the trolley(s) from reaching/touching the front door 104E of the elevator car 102.

When the operator 108 provides the command by pressing the front open button 114L and the rear ground button 114C at the second control panel 110B, the second control panel 110B may communicate the command to the one or more components which may further communicate this command to the front-end actuator 116A. Herein, the one or more components may be connected with the front-end actuator 116A via a wired connection or a wireless connection. Specifically, the one or more components may only communicate the command to the front-end actuator 116A so as to switch the front-end stopper 112A from the first position to the second position. In this case, the one or more components does not communicate the command to the rear-end actuator 116B when the rear-end stopper 112B is already in the first position and thus, does not need to be changed/switched. On receiving the command from the one or more components, the front-end actuator 116A switches from the retracted position to the expanded position. Switching the front-end actuator 116A from the retracted position to the expanded position enables the front-end stopper 112A to switch from the first position to the second position and thereby, operating the front-end stopper 112A in the second position.

After the trolley(s) are inside the elevator car 102 with the required operation of the front-end stopper 112A and the rear-end stopper 112B, the operator 108 selects a destination floor using the destination input buttons 114G-114H as ground floor at the second control panel 110B. In other words, the operator 108 wishes to move the elevator car 102 from the top floor to the ground/bottom floor.

In an exemplary embodiment, when the elevator car 102 reaches the ground floor, a door open signal from a controller (not shown) of the elevator system 100A/100B along with position information of the elevator car 102 may be communicated to the one or more components. Based on the door open signal and the position information, the one or more components may determine that the elevator car 102 has reached to the ground floor and the front door 104E has been opened. On receiving the door open signal and the position information (i.e., ground floor), the one or more components may communicate a command to the front-end actuator 116A to switch from the expanded position to the retracted position and thereby, operating the front-end stopper 112A in the first position again. When the front-end stopper 112A operates in the first position, the at least one trolley may exit the elevator car 102 from the front door 104E. In this embodiment, the front-end stopper 112A automatically switches or operates from the second position to the first position without any command provided by the operator 108 on the second control panel 110B.

In another exemplary embodiment, when the elevator car 102 reaches at the ground floor, the operator 108 may again provide a command by pressing the front ground button 114C at the second control panel 110B to operate the front-end stopper 112A in the first position i.e. to switch from the second position to the first position. When the operator 108 provides the command by pressing the front ground button 114C at the second control panel 110B, the second control panel 110B may communicate the command to the one or more components which may further communicate the command to the front-end actuator 116A. On receiving the command from the one or more components, the front-end actuator 116A switches from the expanded position to the retracted position and thereby, operating the front-end stopper 112A in the first position again. When the front-end stopper 112A operates in the first position, the trolley(s) may exit the elevator car 102 from the front door 104E.

Although, the present invention explains the exemplary scenario I where only rear-end stopper 112B is operated in the second position and scenario II where only front-end stopper 112A is operated in the second position; however, it is understood for a person skilled in the art that the scenarios where both the rear-end stopper 112B and the front-end stopper 112A are operated in the second position at the same time, are also within the scope of the present invention.

It has been described herein that the button 114A is pressed by the operator 108 to operate the front-end stopper 112A in the first position and the button 114B is pressed by the operator 108 to operate the rear-end stopper 112B in the first position. However, it is understood by a person skilled in the art that the front-end stopper 112A and the rear-end stopper 112B can be automatically operated or switched to the first position by using inputs from door open signal and position information as explained above. Moreover, the open status of the doors 104E, 104F and the current position of the elevator car 102 may also be used by the one or more components to automatically switch the one or more dynamic stoppers 112A, 112B from the first position to the second position.

Although, the buttons 114B-114D on the first control panel 110A and the buttons 114L, 114C-114D on the second control panel 110B are used by the operator 108 to switch the dynamic stoppers 112A, 112B from the first position to the second position; however, it is understood for a person skilled in the art that the dynamic stoppers 112A, 112B can be operated or switched from the first position to the second position using two toggle buttons or two-state buttons. For an example, a first button may be a button dedicated to operate the front-end stopper 112A in the first position or in the second position. Moving/pressing the first button would cause the front-end stopper 112A to operate in the first position and pressing the first button again would cause the front-end stopper 112A to operate in the second position. In the same manner, a second button may be a button dedicated to operate the rear-end stopper 112B in the first position or in the second position. Moving/pressing the second button would cause the rear-end stopper 112B to operate in the first position and pressing the second button again would cause the rear-end stopper 112B to operate in the second position.

As explained above, FIG. 3A of the present invention depicts the actuator 116 (116A, 116B) operating in the retracted position thereby, enabling the dynamic stopper 112 (112A, 112B) coupled with the actuator 116 to operate in the first position (i.e. grounded along with the platform 106). FIG. 3B of the present invention depicts the actuator 116 (116A, 116B) operating in the expanded position thereby, enabling the dynamic stopper 112 (112A, 112B) coupled with the actuator 116 to operate in the second position (i.e. elevated from the platform 106). In an exemplary embodiment, the dynamic stopper 112 (112A, 112B) may be of approximately 65 milli-meter (mm) height and may switch from the first position to the second position or vice-versa in 5 seconds to 10 seconds.

Moreover, in the second position, the one or more dynamic stoppers 112 are elevated at a predetermined angle with respect to the platform 106. In an exemplary embodiment, the predetermined angle for elevating the one or more dynamic stoppers 112 may range from 30 degree to 90 degree. The predetermined angle may be decided by a manufacturer of the elevator car 102 or can be customized on the need basis but should be enough and sufficient to restrict the movement of the trolley(s). For an instance, the predetermined angle for elevating the one or more dynamic stoppers 112 may be based on a diameter of a roller of the trolley/s.

Referring to FIGS. 3A and 3B, the actuator 116 is coupled to a cylindrical rod 124 and a retractable arm 118 moves inside and outside the cylindrical rod 124. Further, the retractable arm 118 is coupled to a limb/arm 120 and the limb 120 is installed on a flange 122 connected to the platform 106. As can be seen in FIG. 3B, the actuator 116 operating in the expanded position has the retractable arm 118 which is connected to the limb 120. In FIG. 3A, the retractable arm 118 of the actuator 116 retracts back in the cylindrical rod 124 of the actuator 116 when the actuator 116 operates in the retracted position.

FIG. 3C depicts an exemplary trolley 126 according to an exemplary embodiment of the invention. The trolley(s) 126 can be seen stopped on the platform 106 of the elevator car 102 when the dynamic stopper 112 is in the second position. The dynamic stopper 112 being in the second position restricts the movement of the trolley(s) 126 as explained above in details.

FIG. 3D depicts a cross-sectional view 300D of an exemplary dynamic stopper 112 according to an exemplary embodiment of the invention. The dynamic stopper 112 on the platform 106 may comprise a shaft, a stopper top plate of approximately 5 milli meter (mm) thick SS chequered plate, and a stopper bracket. The square shaft may be of approximately 32 milli meter (mm) and made up of En8 Steel that is toughened. Further, the stopper bracket may be MS fabricated, sandblasted and powder coated.

FIG. 4 depicts a block diagram of different components of an exemplary one or more components 400 according to an exemplary embodiment of the invention. The one or more components 400 may installed anywhere in the elevator system 100A/100B. In an exemplary embodiment, the one or more components 400 is installed near a first/second control panel 110A-110B. In an exemplary embodiment, the one or more components 400 is installed near an actuator 112. The one or more components 400 may comprise of, but is not limited to, a communication unit 402, a battery 404, a memory 406, and/or a processor 408. The communication unit 402 may be configured to receive a command from a first/second control panel 110A-110B via a wired connection or a wireless connection when an operator 108 presses one or more button/s as explained above. The communication unit 402 may be configured to communicate the command to one or more actuators 116A, 116B via a wired connection or a wireless connection. The battery 404 may be configured to provide power to the one or more components 400 so that the one or more components 400 can be operational. The memory 406 may be configured to store the commands received from the control panel 110.

Moreover, the communication unit 402, the battery 404, the memory 406 may be communicably coupled with the processor 408. The different units described herein are exemplary. The invention may be performed using one or more units. For example, the tasks executed by the communication unit 402, the battery 404, the memory 406 and/or the processor 408 may be performed by a single unit. Alternatively, more number of units as described herein may be used to perform the present invention.

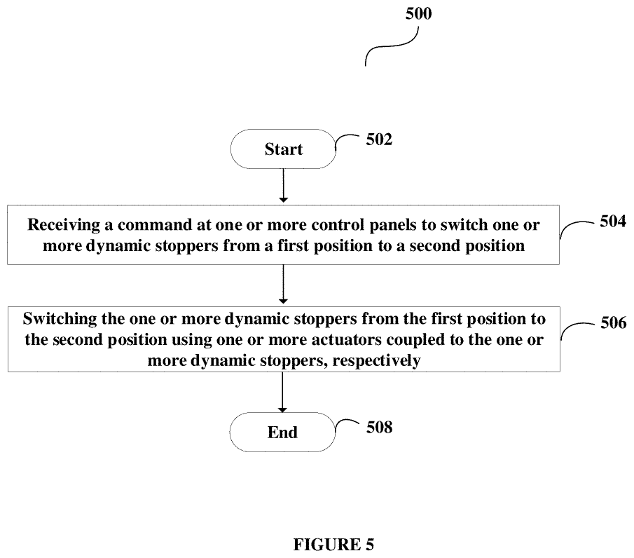

FIG. 5 depicts a flowchart outlining the features of the invention in an exemplary embodiment of the invention. The method flowchart 500 describes a method for operating one or more dynamic stoppers 112A, 112B in an elevator car 102. The method flowchart 500 starts at step 502.

At step 504, a command is received at a one or more control panels 110A-110B to switch one or more dynamic stoppers 112A, 112B from a first position to a second position. The one or more dynamic stoppers 112A, 112B are installed on a platform 106 of an elevator car 102 and the elevator car 102 comprises one or more doors 104E, 104F. Also, the one or more control panels 110A-110B is installed in the elevator car 102. In an exemplary embodiment, the first position corresponds to a position of the one or more dynamic stoppers 112A, 112B grounded along the platform 106 and the second position corresponds to a position of the one or more dynamic stoppers 112A, 112B elevated from the platform 106. This has been discussed in greater details in FIGS. 1 and 2 above.

At step 506, the one or more dynamic stoppers 112A, 112B are switched from the first position to the second position using one or more actuators 116A, 116B coupled to the one or more dynamic stoppers 112A, 112B, respectively. This has been discussed in greater details in FIGS. 1, 2, 3A-3B above. Then, the method 500 may end at step 508.

The present invention is applicable in various industries/fields such as hospitality industry, airports, schools, colleges, offices, and any such industry/field that is well known in the art and where the elevator car 102 is used.

The embodiments of the invention discussed herein are exemplary and various modification and alterations to a person skilled in the art are within the scope of the invention.

The order of execution or performance of the operations in examples of the invention illustrated and described herein is not essential, unless otherwise specified. That is, the operations may be performed in any order, unless otherwise specified, and examples of the invention may include additional or fewer operations than those disclosed herein. For example, it is contemplated that executing or performing a particular operation before, contemporaneously with, or after another operation is within the scope of aspects of the invention.

When introducing elements of aspects of the invention or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C”.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. An elevator system comprising:
an elevator car comprising:
one or more doors;
a platform for accommodating at least one trolley;
one or more control panels; and
one or more dynamic stoppers installed on the platform and configured to operate in a first position and a second position; and
one or more actuators coupled to the one or more dynamic stoppers, respectively and configured to switch the one or more dynamic stoppers from the first position to the second position when a command is provided from the one or more control panels.

2. The elevator system of claim 1, wherein the one or more doors comprise a front door and a rear door of the elevator car, and wherein the one or more control panels comprise a first control panel located near to the front door and a second control panel located near to the rear door.

3. The elevator system of claim 2, wherein the one or more dynamic stoppers comprise a front-end stopper (FES) installed near the front door and a rear-end stopper (RES) installed near the rear door of the elevator car.

4. The elevator system of claim 3, wherein the one or more actuators comprise a front-end actuator coupled to the front-end stopper and a rear-end actuator coupled to the rear-end stopper, respectively.

5. The elevator system of claim 4, wherein the front-end actuator and the rear-end actuator operate in an expanded position to articulate the front-end stopper and the rear-end stopper to the second position.

6. The elevator system of claim 4, wherein the front-end actuator and the rear-end actuator operate in a retracted position to articulate the front-end stopper and the rear-end stopper to the first position.

7. The elevator system of claim 1, wherein the first position corresponds to a position of the one or more dynamic stoppers grounded along the platform and the second position corresponds to a position of the one or more dynamic stoppers elevated from the platform.

8. The elevator system of claim 1, wherein in the second position, the one or more dynamic stoppers are elevated at a predetermined angle with respect to the platform based on a diameter of a roller of the at least one trolley.

9. The elevator system of claim 3, wherein the front-end stopper operates in the second position and the rear-end stopper operates in the first position when the at least one trolley enters from the rear door, and wherein the front-end stopper and the rear-end stopper operate in the first position when the at least one trolley exits from the front door.

10. The elevator system of claim 1, wherein the command from each of the one or more control panels is provided by an operator, wherein the operator inserts a physical key and presses a key switch button on the one or more control panels.

11. The elevator system of claim 3, wherein the front-end stopper operates in the first position and the rear-end stopper operates in the second position when the at least one trolley enters from the front door, wherein the front-end stopper and the rear-end stopper operate in the first position when the at least one trolley exits from the rear door.

12. The elevator system of claim 10, wherein the one or more dynamic stoppers switch from the first position to the second position when the key switch button is operated by the operator.

13. The elevator system of claim 1, wherein each of the one or more actuators is coupled to an arm and the arm is installed on a flange connected to the platform.

14. The elevator system of claim 1, wherein each of the one or more actuators is connected with one or more components and the one or more components is connected with each of the one or more control panels.

15. The elevator system of claim 14, wherein each of the one or more control panels communicates the command to the one or more components when a command is provided at the one or more control panels and the one or more components communicates the command to the one or more actuators.

16. The elevator system of claim 5, wherein the front-end actuator and the rear-end actuator operate in the expanded position on receiving a command from the one or more components enabling the one or more dynamic stoppers to operate in the second position.

17. The elevator system of claim 1, wherein the one or more dynamic stoppers operating in the first position do not restrict the movement of the at least one trolley, wherein the one or more dynamic stoppers operating in the second position restrict the movement of the at least one trolley.

18. The elevator system of claim 1, wherein the one or more dynamic stoppers automatically switch from the first position to the second position based on inputs from one or more sensors installed in the elevator car,

19. The elevator system of claim 1, wherein the one or more dynamic stoppers automatically switch from the second position to the first position based on a door opening signal when the elevator car reaches a destination floor.

20. A method comprising:
receiving a command at one or more control panels to switch one or more dynamic stoppers from a first position to a second position, wherein
the one or more dynamic stoppers are installed on a platform of an elevator car,
the elevator car comprises one or more doors, and
the one or more control panels is installed in the elevator car;
switching the one or more dynamic stoppers from the first position to the second position using one or more actuators coupled to the one or more dynamic stoppers, respectively.
